(19) United States
(12) Patent Application Publication
(10) Pub. No.: US 2022/0299791 A1
(43) Pub. Date: Sep. 22, 2022

(54) Detachable Bluetooth Glasses

(71) Applicant: Guangzhou Jixing Glasses Co., Ltd., Guangzhou City (CN)

(72) Inventor: Feng GAO, Guangzhou City (CN)

(21) Appl. No.: 17/307,645

(22) Filed: May 4, 2021

(30) Foreign Application Priority Data
Mar. 20, 2021 (CN) 202120572701.8

(51) Int. Cl. G02C 1/04; G02C 11/00

(52) U.S. Cl. CPC G02C 1/04; G02C 11/10

(57) ABSTRACT

The present application discloses a detachable bluetooth glasses, comprising a spectacle frame and a lenses frame, the spectacle frame is provided with a mounting groove; the spectacle frame comprises a lenses beam and two lenses, two lenses are arranged at the bottom of the lenses beam and distribute alternately; the lenses beam is inserted inside the mounting groove and the lenses beam is detachably connected to the inner wall of the mounting groove. detachable bluetooth glasses of the present application, can be changed the lenses and used according to different situation.

### CROSS-REFERENCE TO RELATED APPLICATIONS

This application claims the benefit of Chinese Patent Application No. 202120572701.8, filed on Mar. 20, 2021 in the National Intellectual Property Administration of China, the disclosure of which is incorporated herein by reference in its entirety.

### TECHNICAL FIELD

The present application relates to a glasses equipment, and in particular to a detachable bluetooth.

### BACKGROUND

At present, glasses are combined with lenses and a frame, which is used to improve the vision, protect eyes or used as decorative accessory. The glasses can correct various kinds of vision problems, including myopia, hyperopia, astigmatism, presbyopia, strabismus or amblyopia etc. Sunglasses which are used for decoration mainly with black lenses, but the black lenses need to be taken off when in the situation of low-light, so in order for multipurpose, two sets of lenses are installed then the sunglasses are available for two situations. And the glasses which are used for correction need to be chosen according to status of vision, so different lenses are needed in different situation, but now the frame and lenses of the glasses are fixed, it causes waste of the frame.

### SUMMARY

In order to overcome the shortcomings of the prior art, an object of the present application is to provide a detachable bluetooth, which's lenses can be taken off and changed, can be used according to different situation.

The object of the present application is achieved by adopting the following technical solutions:

A detachable bluetooth glasses, comprises a spectacle frame and a lenses frame, the spectacle frame is provided with a mounting groove; the spectacle frame comprises a lenses beam and two lenses, two lenses are arranged at the bottom of the lenses beam and distribute alternately; the lenses beam is inserted inside the mounting groove and the lenses beam is detachably connected to the inner wall of the mounting groove.

Preferably, the spectacle frame comprises a spectacle frame rim and two temples, two temples are arranged at two sides of the spectacle frame rim respectively; the mounting groove is arranged at the bottom of the spectacle frame rim.

Preferably, the spectacle frame rim comprises a first rim part and two second rim parts; the first rim part is connected between two second rim parts; the bottom of each second rim part is provided with the mounting groove respectively, a side of each mounting groove closed to each other is all communicated to the first rim part.

Preferably, the first rim part is provided with a first fasten, the middle of the lenses beam is provided with a fasten opening, the first fasten is fixed inside the fasten opening.

Preferably, both sides of the lenses beam are all provided with a second fasten respectively, a side of each mounting groove which far from each other is provided with a clamping slot respectively, the second fastens are fixed inside the clamping slot.

Preferably, one of the temples is provided with a bluebooth module and a loudspeaker, the loudspeaker and the bluebooth module are connected electrically.

Preferably, one of the temples is provided with a battery, the battery, the loudspeaker and the bluebooth module are connected electrically.

Preferably, the battery is a rechargeable battery.

Compared with the prior art, the beneficial effects of some embodiments are: the lenses beam and the mounting groove of the spectacle frame is detachably connected, when the lenses are needed to be changed, takes off the lenses beam from the mounting groove, changes other lenses frame, so, different lenses can be changed according to different situation, widen the range of use and convenient to take off and change.

### BRIEF DESCRIPTION OF DRAWINGS

FIG. 1 is a schematic diagram of a structure of the present application;

FIG. 2 is a schematic diagram of an exploded structure of the present application.

In the figures: 10. spectacle frame; 11. spectacle frame rim; 101. first rim part; 102. second rim part; 111. mounting groove; 1111. clamping slot; 112. first fasten; 12. temple; 13. loudspeaker; 14. rechargeable battery; 20. lenses frame; 21. lenses beam; 22. lenses; 23. second fasten.

### DESCRIPTION OF EMBODIMENTS

In the following, the present application will be further described in conjunction with the drawings and specific implementations. It should be noted that, provided that there is no conflict, the following embodiments or technical features can be combined to form new embodiments. Except special illustration, the materials and equipment used in the embodiment can be get from the market. An example of the embodiment is shown in the drawings, throughout the same or similar label indicates the same or similar element or element with the same or similar function. The following embodiments described with reference drawings are exemplary, are only used to explain the application, is not intended to limit the scope of the application.

In the description of the present application, it should be understood that the orientation or positional relationship indicated by the terms “center”, “upper”, “lower”, “front”, “back”, “vertical”, “horizontal”, “top”, “bottom”, “inside”, “outside”, etc. are based on the orientation or positional relationship shown in the drawings, and are merely for the convenience of describing the present application and simplifying the description, and do not indicate or imply that the device or component referred to have a specific orientation or are constructed and operated in a specific orientation and therefore shall not to be construed as limiting the present application.

In the description of the present application, unless otherwise explicitly specified and defined, it should be noted that the term, “connected to” is to be understood broadly, and may be, for example, fixedly connected or detachably connected, or integrally connected; may be mechanically connected or electrically connected; may be directly connected, or indirectly connected through an intermediate medium, and may be the internal communication of the two components or the interaction relation of the two components. The specific meaning of the above terms in the present application can be understood in a specific situation by those skilled in the art.

The terms “first”, “second” etc. in the description and claims and the said drawings of the present application are used to distinguish similar objects, do not be used to describe a specific order or sequence. In addition, the term “comprise” and any variation of it is intended to cover non exclusive inclusion. For example, a process, a method, a system, a product or a device that comprise a series of steps or units need not be limited to those steps or units that are clearly listed, but may comprise those that are not clearly listed or inherent other steps or units for the process, method, product or device other steps or units.

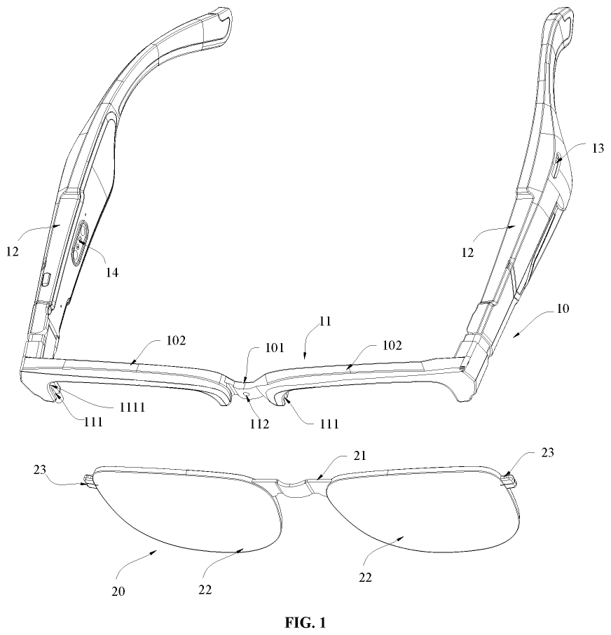

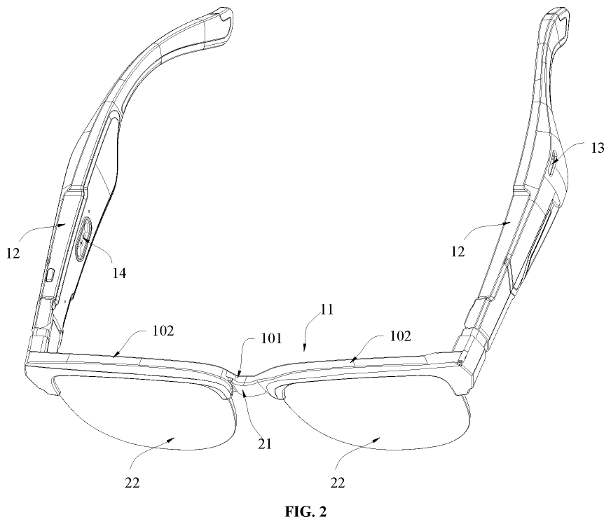

As shown in FIGS. 1 and 2, a detachable bluetooth glasses comprises a spectacle frame 10 and a lenses frame 20, the spectacle frame 10 is provided with a mounting groove 111. Specifically, the spectacle frame 20 comprises a lenses beam 21 and two lenses 22, two lenses 22 are arranged at the bottom of the lenses beam 21, and two lenses 22 distribute alternately on the lenses beam 21. The lenses beam 21 is inserted inside the mounting groove 111, and the lenses beam 21 is detachably connected to the inner wall of the mounting groove 111.

On the base of the said structure, when using the detachable bluetooth glasses of the present application, the lenses beam 21 can be installed in the mounting groove 111 and connected to the inner wall of the mounting groove 111, due to the limitation of the mounting groove 111, the lenses beam 21 can be installed in the spectacle frame 10 stably, and the exposure of the lenses beam 21 can be prevented. When the lenses 22 needs to be changed, taking off the lenses beam 21 from the mounting groove 111, installing another lenses frame 20, so different lenses 22 can be changed according to different situation, widen the range of use and convenient to take off and change.

Preferably, the spectacle frame 10 of the embodiment comprises a spectacle frame rim 11 and two temples 12, two temples 12 are arranged at two sides of the spectacle frame rim 11 respectively and the mounting groove 111 is arranged at the bottom of the spectacle frame rim 11. When using, the lenses beam 21 is connected to the mounting groove 111 of the spectacle frame rim 11, after assembling, hanging the temples 12 on both side on the ears.

Specifically, the spectacle frame rim 11 comprises a first rim part 101 and two second rim parts 102; the first rim part 101 is connected between two second rim parts 102. On the base of the said structure, the bottom of each second rim part 102 is provided with the mounting grooves 111 respectively, a side of each mounting groove 111 closed to each other is all communicated to the first rim part 101.

So that, when assembling the lenses beam 21, a part of the lenses beam 21 on the upper side of two lenses 22 is assembled correspondingly inside two mounting grooves 111, and the middle part of the lenses beam 21 extends from the mounting groove 111 in order to prevent the interference of assembling and stabilize the assembling.

Preferably, the first rim part 101 is provided with a first fasten 112, the middle of the lenses beam 21 is provided with a fasten opening correspondingly, the middle part of the lenses beam 21 extends from the mounting groove 111 and corresponding to the first rim part 101, now the first fasten 112 is fixed inside the fasten opening, that means both sides of the lenses beam 21 are limited by the mounting groove 111 and the middle part of the lenses beam 21 is limited by the first fasten 112 and the fasten opening, the assembling is more stable.

Of course, both sides of the lenses beam 21 can be all provided with a second fasten 23 respectively, a side of each mounting grooves 111 which far from each other is provided with a clamping slot 1111 respectively, then, after the lenses beam 21 is assembled to the mounting groove 111, the second fastens 23 of both sides of the lenses beam 21 are fixed inside the clamping slot 1111 of the mounting grooves 111 correspondingly.

It should be noted that, detachable connection of the lenses beam 21 and the mounting grooves 111 also can be achieved by plug-in or screwing way.

Preferably, one of the temples 12 is provided with a bluebooth module and a loudspeaker 13, the loudspeaker 13 and the bluebooth module are connected electrically, so, when using, the detachable blue tooth can be connected wirelessly with cellphone or other electronic equipment by the bluebooth module and play music of cellphone or other electronic equipment by the loudspeaker 13, be more functional.

Preferably, one of the temples 12 is provided with a battery, the battery, the bluebooth module and the loudspeaker 13 are connected electrically, so, the battery can supply power for the bluebooth module and the loudspeaker 13, that means the glasses can work without power cable, more convenient to use.

More specifically, the battery is a rechargeable battery 14, the charging interface of the rechargeable battery 14 can be exposed on the inner side of the temples 12, in order to the charging of rechargeable battery 14, convenient for charging, does not influence on the explosion of charging interface.

Although only some parts and embodiments of the application have been illustrated and described, many modifications and changes (such as changes in size, structure, shape and proportion, installation arrangement, material use, color, orientation, etc.) can be thought of by those skilled in the art without actually departing from the scope and spirit of the claims.

It should be noted at last, various modifications could be made to the embodiments by those of ordinary skill in the art without departing from the true spirit and scope of the disclosure. And those modified embodiments are covered by the claims of the disclosure.

1. A detachable bluetooth glasses, comprising a spectacle frame and a lenses frame, the spectacle frame is provided with a mounting groove; the spectacle frame comprises a lenses beam and two lenses, two lenses are arranged at the bottom of the lenses beam and distribute alternately; the lenses beam is inserted inside the mounting groove and the lenses beam is detachably connected to the inner wall of the mounting groove.

2. The detachable bluetooth glasses according to claim 1, wherein the spectacle frame comprises a spectacle frame rim and two temples, two temples are arranged at two sides of the spectacle frame rim respectively; the mounting groove is arranged at the bottom of the spectacle frame rim.

3. The detachable bluetooth glasses according to claim 2, wherein the spectacle frame rim comprises a first rim part and two second rim parts; the first rim part is connected between two second rim parts; the bottom of each second rim part is provided with the mounting groove respectively, a sides of each mounting grooves closed to each other is communicated to the first rim part.

4. The detachable bluetooth glasses according to claim 3, wherein the first rim part is provided with a first fasten, the middle of the lenses beam is provided with a fasten opening, the first fasten is fixed inside the fasten opening.

5. The detachable bluetooth glasses according to claim 4, wherein both sides of the lenses beam are all provided with a second fasten respectively, a side of each mounting groove which far from each other is provided with a clamping slot respectively, the second fastens are fixed inside the clamping slot.

6. The detachable bluetooth glasses according to claim 2, wherein one of the temples is provided with a bluebooth module and a loudspeaker, the loudspeaker and the bluebooth module are connected electrically.

7. The detachable bluetooth glasses according to claim 6, wherein one of the temples is provided with a battery, the battery, the loudspeaker and the bluebooth module are connected electrically.

8. The detachable bluetooth glasses according to claim 7, wherein the battery is a rechargeable battery.

9. The detachable bluetooth glasses according to claim 3, wherein one of the temples is provided with a bluebooth module and a loudspeaker, the loudspeaker and the bluebooth module are connected electrically.

10. The detachable bluetooth glasses according to claim 9, wherein one of the temples is provided with a battery, the battery, the loudspeaker and the bluebooth module are connected electrically.

11. The detachable bluetooth glasses according to claim 10, wherein the battery is a rechargeable battery.

12. The detachable bluetooth glasses according to claim 4, wherein one of the temples is provided with a bluebooth module and a loudspeaker, the loudspeaker and the bluebooth module are connected electrically.

13. The detachable bluetooth glasses according to claim 12, wherein one of the temples is provided with a battery, the battery, the loudspeaker and the bluebooth module are connected electrically.

14. The detachable bluetooth glasses according to claim 13, wherein the battery is a rechargeable battery.

15. The detachable bluetooth glasses according to claim 5, wherein one of the temples is provided with a bluebooth module and a loudspeaker, the loudspeaker and the bluebooth module are connected electrically.

16. The detachable bluetooth glasses according to claim 15, wherein one of the temples is provided with a battery, the battery, the loudspeaker and the bluebooth module are connected electrically.

17. The detachable bluetooth glasses according to claim 16, wherein the battery is a rechargeable battery.
